(19) United States
(12) Patent Application Publication
(10) Pub. No.: US 2019/0039604 A1
(43) Pub. Date: Feb. 7, 2019

(54) METHOD AND DEVICE FOR THE DRIVERLESS DRIVING OF A MOTOR VEHICLE PARKED AT A START POSITION OF A PARKING FACILITY

(71) Applicant: Robert Bosch GmbH, Stuttgart (DE)

(72) Inventors: Juergen Auracher, Oberstenfeld (DE); Rolf Nicodemus, Bietigheim-Bissingen (DE); Stefan Nordbruch, Kornwestheim (DE); Stefan Hoffmann, Bietigheim (DE)

(73) Assignee: Robert Bosch GmbH, Stuttgart (DE)

(21) Appl. No.: 15/757,695

(22) PCT Filed: Jul. 15, 2016
(86) PCT No.: PCT/EP2016/066855

§ 371 Date: Mar. 6, 2018

(30) Foreign Application Priority Data
Sep. 10, 2015 (DE) 102015217278.3

(51) Int. Cl. B60W 30/06; G05D 1/02

(52) U.S. Cl. CPC B60W 30/06; B60W 2550/40; G05D 2201/0213; G05D 1/0225

(57) ABSTRACT

A method for the driverless driving of a motor vehicle parked at a start position of a parking facility from the start position to a destination position of the parking facility. The method includes checking whether one or several of the following minimum conditions are fulfilled: an order for the driverless driving exists, the driver of the parked motor vehicle handed over the responsibility for the parked motor vehicle, and a minimum distance of one or multiple persons from the parked motor vehicle is maintained, and beginning with the driverless driving of the motor vehicle only if one or several of the minimum conditions are fulfilled. A corresponding device and a computer program are also described.

### FIELD

The present invention relates to a method and a device for the driverless driving of a motor vehicle parked at a start position of a parking facility, and the present invention furthermore relates to a computer program.

### BACKGROUND INFORMATION

German Patent Application No. DE 10 2012 222 562 A1 describes a system for managed parking areas for transferring a vehicle from a start position to a destination position.

### SUMMARY

An object of the present invention includes providing for the efficient driverless driving of a motor vehicle parked at a start position of a parking facility to a destination position of the parking facility.

Advantageous developments and refinements of the present invention are described herein.

According to one aspect of the present invention, a method is provided for the driverless driving of a motor vehicle parked at a start position of a parking facility from the start position to a destination position of the parking facility, comprising the following steps:
checking whether one or several of the following minimum conditions are fulfilled:
   an order for the driverless driving exists,
   the driver of the parked motor vehicle handed over the responsibility for the parked motor vehicle,
   a minimum distance of one or multiple persons from the parked motor vehicle is maintained,
the driverless driving of the motor vehicle is begun only if one or several of the minimum conditions are fulfilled.

According to another aspect of the present invention, a device is provided for the driverless driving of a motor vehicle parked at a start position of a parking facility from the start position to a destination position of the parking facility, the device being designed to implement the method for the driverless driving of a motor vehicle parked at a start position of a parking facility from the start position to a destination position of the parking facility.

According to another aspect of the present invention, a computer program is provided, which includes program code for implementing the method for the driverless driving of a motor vehicle parked at a start position of a parking facility from the start position to a destination position of the parking facility when the computer program is run on a computer.

The present invention thus comprises in particular and inter alia the idea of beginning with the driverless driving of the motor vehicle from the start position to the destination position only if one or several of the minimum conditions are fulfilled. The minimum conditions ensure that the parked motor vehicle is indeed intended or destined for driverless driving. This yields in particular the technical advantage that the motor vehicle is able to be driven driverlessly from the start position to the destination position in an efficient manner. This yields in particular the technical advantage of being able to increase a safety for surrounding persons. A risk of collision is thus advantageously reduced or even excluded for these persons.

By checking the minimum condition whether the order for the driverless driving exists, it is thus in particular advantageously possible to ensure that precisely this motor vehicle is now to be driven driverlessly from its start position to the destination position. It is thus advantageously possible to avoid mix-ups with other motor vehicles that are located near the start position.

The check to determine whether the driver of the parked motor vehicle handed over the responsibility for the parked motor vehicle in particular has the technical advantage of ensuring that the parked motor vehicle is now no longer driven by its driver, but is rather itself ready to take over driving and/or to be driven in a remote-controlled manner.

The responsibility may be transferred for example as follows:

The driver wants to activate an automatic parking process (AVP: automated valet parking, see also the explanations below), for example by using a smart phone app. The driver thus executes the app on his smart phone in order to start or activate the automatic parking process. The app, which is controlled for example via a parking facility management system, shows for example the General Terms and Conditions for the AVP. The General Terms and Conditions regulate for example the method of payment, product liability, etc. But in particular also the criteria.

The driver is prompted by the app to accept these. If the driver accepts the General Terms and Conditions, the responsibility, according to one specific embodiment, then passes over to the motor vehicle and/or the parking facility management system.

That is to say that, according to one specific embodiment, the check to determine whether the responsibility for the parked motor vehicle was handed over by the driver of the parked motor vehicle comprises a check to determine whether the driver accepted the General Terms and Conditions for the automatic parking process.

According to one specific embodiment, the check to determine whether the responsibility for the parked motor vehicle was handed over by the driver of the parked motor vehicle comprises a check to determine whether the driver ordered a start or beginning of the driverless driving process.

The check to determine whether a minimum distance is maintained before the driverless driving process is started has in particular the technical advantage of reducing a collision risk for the surrounding persons. The minimum distance is 2 m for example.

Driverless driving comprises in particular that the vehicle drives autonomously, that is, independently, from the start position to the destination position. Driverless driving comprises in particular that the motor vehicle drives in remote-controlled fashion from the start position to the destination position. Driverless driving comprises in particular that the motor vehicle drives a section from the start position to the destination position autonomously and is controlled remotely for another section from the start position to the destination position.

That is to say that when the motor vehicle is driven in driverless fashion, it is no longer necessary for a driver or human person to be located in the vehicle to drive the vehicle. The vehicle thus drives without manual intervention of a driver located within the vehicle. This is in particular due to the fact that the motor vehicle drives independently, that is, autonomously, or is controlled remotely.

A parking facility in the sense of the present invention in particular forms a parking area for motor vehicles. The parking facility thus forms in particular a contiguous area, which is made up of multiple parking spaces (in the case of a parking lot on private property) or parking stalls (in the case of a parking lot on public property). The parking spaces or parking stalls are thus parking positions of the parking facility, on which motor vehicles are able to park.

The start position is thus located in particular within the parking facility. The destination position is thus located in particular within the parking facility. That is to say that the motor vehicle is to be driven and/or is driven in driverless fashion within the parking facility.

According to one specific embodiment, driverless driving is comprised by an automatic parking process. Such an automatic parking process may be called an AVP process, for example. In this context, “AVP” stands for “automated valet parking” and may be translated as “automatic parking process.” In an AVP process, the vehicle is parked automatically within the parking facility and, following the end of a parking period, is automatically driven to a position within or outside of the parking facility, at which a person can again take over the vehicle. The automatic parking process provides for it no longer being necessary for a driver to be located in the vehicle itself. Within the scope of an automatic parking process, the vehicle drives autonomously and/or is controlled remotely.

Vehicles in the sense of the present invention are motor vehicles.

One specific embodiment provides that if one or several of the minimum conditions are fulfilled, a time following the end of the check is measured, which is compared to a predetermined minimum time, the driverless driving of the motor vehicle being begun only when the measured time is equal to or great than the predetermined minimum time.

This in particular yields the technical advantage of being able to ensure that a predetermined minimum time, for example at least 10 s, must have passed before the driverless driving of the motor vehicle is begun. This advantageously makes it possible to increase a safety for surrounding persons further. This in particular yields the technical advantage that in the event that the driver, after having left the motor vehicle, immediately returns to the motor vehicle, for example because he forgot something, a safety is increased for the driver because the driverless driving process was not yet started due to the fact that the minimum time has not yet passed.

Following the passing of the predetermined minimum time, one specific embodiment provides for one or several, preferably all of the minimum conditions to be rechecked as to whether they are fulfilled, the driverless driving being begun only in the event of a fulfillment. Rechecking here means that the check is repeated. There is thus a new check performed to determine whether the minimum condition(s) is/are fulfilled.

This yields in particular the technical advantage of increasing a safety still further.

Another specific embodiment provides for a check to determine whether one or multiple systems for implementing the driverless driving process report an operationally ready operating state, the driverless driving process being begun only if the one or the multiple systems report an operationally ready operating state.

This yields in particular the technical advantage of ensuring efficiently that the motor vehicle and/or an infrastructure of the parking facility, which is required for implementing driverless driving, are ready to drive the motor vehicle in driverless fashion. That is to say that if one of the systems does not yet report an operationally ready operating state, the driverless driving process is not begun.

Once specific embodiment provides for the one or the multiple systems to comprise one or multiple elements selected from the following group of systems: drive system of the motor vehicle, brake system of the motor vehicle, steering system of the motor vehicle, communication system of the motor vehicle, surround sensor system of the motor vehicle, parking assistance system of the motor vehicle, autonomous driving system of the motor vehicle, communication system of the parking facility, surround sensor system of the parking facility, control system of the parking facility for controlling the driverless driving process, remote-control system of the parking facility for controlling the motor vehicle remotely.

This ensures for example that the surround sensor system of the motor vehicle is functioning properly. For normally the motor vehicle requires its surround sensor system in order to be able to navigate autonomously within the parking facility. The motor vehicle in particular requires its surround sensor system in order to be able to detect obstacles in its surroundings so as to be able to react to them adequately.

Communication systems are required in particular so that the motor vehicle is able to communicate with an infrastructure of the parking facility. It is provided for example that a digital map of the parking facility is provided to the motor vehicle via the communication systems, on the basis of which the motor vehicle is able to drive autonomously. Thus, if communication systems are not operationally ready, such a digital map for example cannot be transmitted, which then could result in the motor vehicle driving autonomously within the parking facility in an incorrect manner. According to the present invention, this can be avoided in that a check is performed to determine whether the communication systems report an operationally ready operating state.

One specific embodiment provides that, in the event of the fulfillment of the minimum condition that the responsibility for the motor vehicle was handed over by the driver, the handover of responsibility is documented electronically.

This yields in particular the technical advantage of being able to check even at a later time whether the driver actually handed over the responsibility. This is relevant in particular if problems arose within the driverless driving process.

One specific embodiment provides for one or more of the method steps described here to be documented electronically.

This yields in particular the technical advantage of being able to review after the fact what occurred in detail.

Another specific embodiment provides for the beginning of the driverless driving process to comprise a starting of the motor vehicle so that the motor vehicle is started only when one or more of the minimum conditions are fulfilled.

This yields in particular the technical advantage of being able to increase a safety for surrounding persons even further. For as long as a drive motor of the motor vehicle has not yet started, the vehicle is not yet able to drive off. The motor vehicle is thus advantageously prevented from driving off unintentionally. That is to say that a starting of the motor vehicle means that a drive motor of the motor vehicle is started, that is, is switched on.

Another specific embodiment provides for the driverless driving of the motor vehicle to begin only when all minimum conditions are fulfilled.

This yields in particular the technical advantage of being able to implement driverless driving even more efficiently. This in particular advantageously increases a safety for surrounding persons even further. Generally, a safety for the motor vehicle and/or for the parking facility is increased further.

One specific embodiment provides for the destination position to be a parking position of the parking facility or a pick-up position of the parking facility, at which a person is able to pick up the motor vehicle.

This yields in particular the technical advantage of being able to implement an automatic parking process efficiently.

If the destination position is a parking position of the parking facility, it is particularly provided that the start position is a handover position of the parking facility. A handover position of the parking facility indicates a position of the parking facility, at which the driver is to park his motor vehicle for implementing an automatic parking process. That is to say that the driver parks his vehicle at the handover position and leaves his vehicle. Subsequently, if the minimum conditions are fulfilled, the automatic parking process is begun. The motor vehicle then drives in driverless fashion to the parking position and parks itself there.

If the destination position is a pick-up position of the parking facility, at which a person is able to pick up the motor vehicle, it is particularly provided that the start position is a parking position of the parking facility. That is to say that the parked motor vehicle is parked at the parking position.

One specific embodiment provides for the features of the present invention to be applied also in the case in which the motor vehicle is to be driven and/or is driven in driverless fashion from the handover position to the parking position and then is to be driven and/or is driven in driverless fashion from the parking position to the pick-up position. Each time, the driverless driving begins only if at least one of the minimum conditions is fulfilled.

The formulation “respectively” comprises in particular the formulation “and/or”.

One specific embodiment provides the following steps:
checking whether one or several of the following additional conditions are fulfilled:
   the motor vehicle is parked correctly,
   the motor vehicle is locked.
beginning with the driverless driving of the motor vehicle only if in addition to the minimum condition(s) one or several of the additional conditions are fulfilled.

This yields in particular the technical advantage of being able to ensure efficiently that the motor vehicle is ready for driverless driving.

Checking whether the motor vehicle is parked correctly comprises in particular a check to determine whether the motor vehicle is shut off (that is, in particular whether a drive motor of the motor vehicle is shut off) and/or whether a gear is engaged and/or whether a parking brake is activated, that is, is engaged for example.

The present invention is explained in greater detail below with reference to preferred exemplary embodiments.

### BRIEF DESCRIPTION OF THE DRAWINGS

FIG. 1 shows a flow chart of a method for the driverless driving of a motor vehicle parked at a start position of a parking facility from the start position to a destination position of the parking facility and

FIG. 2 shows a device for the driverless driving of a motor vehicle parked at a start position of a parking facility from the start position to a destination position of the parking facility.

### DETAILED DESCRIPTION OF EXAMPLE EMBODIMENTS

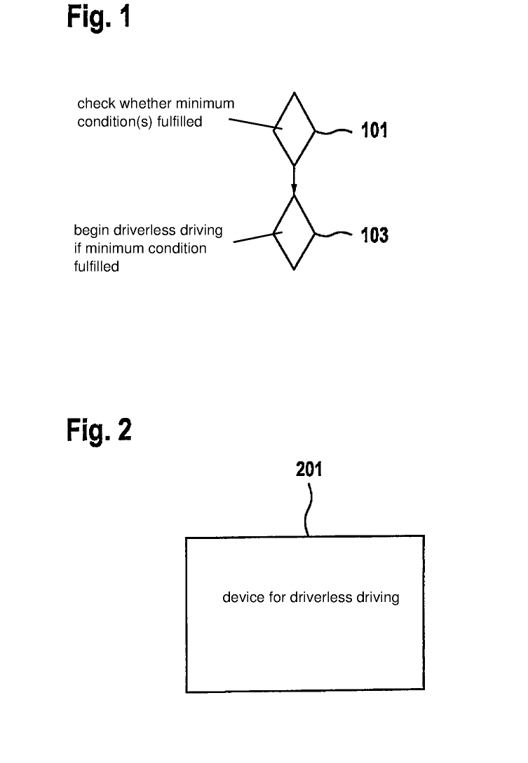

FIG. 1 shows a flow chart of a method for the driverless driving of a motor vehicle parked at a start position of a parking facility from the start position to a destination position of the parking facility.

The method includes the following steps:
checking 101 whether one or several of the following minimum conditions are fulfilled:
   an order for the driverless driving exists,
   the driver of the parked motor vehicle handed over the responsibility for the parked motor vehicle,
   a minimum distance of one or multiple persons from the parked motor vehicle is maintained,
beginning 103 with the driverless driving of the motor vehicle only if one or several of the minimum conditions are fulfilled.

The check whether the minimum distance is maintained comprises in particular sensing the surroundings using a surround sensor system of the parking facility. That is to say that the surround sensor system senses the motor vehicle and its surroundings. This sensing is the basis in particular for determining whether one or multiple persons are located in the surroundings. Based on this determination, a distance between the motor vehicle and the person(s) is ascertained, this ascertained distance then being compared to a minimum distance in order to check whether the minimum distance is maintained.

Alternatively or additionally, it is possible for the check, whether the minimum distance is maintained, to be performed by a surround sensor system of the motor vehicle itself. That is to say that the motor vehicle for example starts only if it has determined using its surround sensor system that persons in its surroundings maintain a minimum distance from the motor vehicle.

One specific embodiment provides for the check, whether the minimum distance is maintained, to be performed by the motor vehicle and/or by a vehicle-external parking facility management server of the parking facility. For this purpose, the parking facility management server evaluates the surroundings detected by the surround sensor system of the parking facility.

The check, whether an order exists for the driverless driving operation, comprises in particular a query to a parking facility management server of the parking facility as to whether a reservation for a parking position exists for the motor vehicle or whether the motor vehicle is registered for an automatic parking process. If a reservation or a registration exists, then there is a provision to begin the driverless driving process.

Beginning, according to step 103, comprises for example that a start command is transmitted to the communication system of the motor vehicle via a communication network, in response to which the motor vehicle is able to start and/or starts.

A communication network comprises in particular a mobile telephony network and/or WLAN network and/or LoRa communication network. “LoRa” in this context stands for “low-power wide-range communication”.

Persons in the surroundings of the motor vehicle are for example former occupants of the motor vehicle and/or the former driver of the motor vehicle.

FIG. 2 shows a device 201 for the driverless driving of a motor vehicle parked at a start position of a parking facility from the start position to a destination position of the parking facility.

Device 201 is designed to implement or carry out the method for the driverless driving of a motor vehicle parked at a start position of a parking facility from the start position to a destination position of the parking facility.

Device 201 comprises for example a surround sensor system and a communication system. The surround sensor system is provided to sense the surroundings of the motor vehicle, as described previously. The communication system is provided for example to transmit a start command for starting the motor vehicle to the motor vehicle via a communication network.

According to one specific embodiment, a parking facility is provided that comprises device 201.

According to one specific embodiment, a motor vehicle is provided that comprises device 201.

The present invention thus comprises in particular and inter alia the idea of providing a technical solution, which is able to ensure a safe start of the motor vehicle for implementing an automatic parking process. This begins from a start position, which is for example a handover position, it being possible to call the handover position also a drop zone. A motor vehicle, which is able to drive in driverless fashion within a parking facility and which is able to park and/or unpark automatically, may be called an AVP motor vehicle.

In accordance with the present invention, various minimum criteria (minimum conditions) are checked as to whether they are fulfilled. This is done before beginning with the driverless driving of the motor vehicle, that is, in particular before the motor vehicle is started.

The minimum criteria or minimum conditions comprise one or more of the following conditions:

The driver ordered the process (the driverless driving or the automatic parking process).

The responsibility for the motor vehicle has verifiably been transferred from the driver to an AVP system.

The former driver and/or the former vehicle occupants have a defined minimum distance from the motor vehicle, one that is adjustable for example. The minimum distance is 2 m for example.

According to one specific embodiment, a defined, in particular adjustable, minimum time must have passed since the fulfillment of one or more of the aforementioned minimum criteria or minimum conditions (time following the end of the check). The minimum time is 10 s for example.

According to one specific embodiment, AVP systems report an “ok”.

That is to say that one or more systems for implementing the driverless driving must report an operationally ready operating state for the driverless driving of the motor vehicle to begin.

According to one specific embodiment, at least motor vehicle-internal systems and systems of a parking facility infrastructure must respectively report an operationally ready operating state for the driverless driving to begin.

According to one specific embodiment, the handover of the responsibility is documented electronically.

Following the fulfillment of the minimum condition or minimum conditions, the process for the start and the start for the driverless drive begins.

1-13. (canceled)

14. A method for driverless driving of a motor vehicle parked at a start position of a parking facility from the start position to a destination position of the parking facility, the method comprising:
checking whether at least one of the following minimum conditions are fulfilled:
an order for the driverless driving exists,
the driver of the parked motor vehicle handed over responsibility for the parked motor vehicle, and
a minimum distance of one or multiple persons from the parked motor vehicle is maintained; and
beginning the driverless driving of the motor vehicle only if the at least one minimum condition is fulfilled.

15. The method as recited in claim 14, wherein, when the at least one the minimum conditions is fulfilled, a time following an end of the check is measured, which is compared to a predetermined minimum time, the driverless driving of the motor vehicle being begun only when the measured time is equal to or great than the predetermined minimum time.

16. The method as recited in claim 15, wherein, following the passing of the predetermined minimum time, at least one of the minimum conditions are rechecked as to whether they are fulfilled,
the driverless driving being begun only in the event of a fulfillment.

17. The method as recited in claim 14, wherein a check is performed to determine whether at least one system for implementing the driverless driving report an operationally ready operating state, the driverless driving process being begun only if the at least one system reports an operationally ready operating state.

18. The method as recited in claim 17, wherein the at least one system comprises at least one element selected from the following group of systems: a drive system of the motor vehicle, a brake system of the motor vehicle, a steering system of the motor vehicle, a communication system of the motor vehicle, a surround sensor system of the motor vehicle, a parking assistance system of the motor vehicle, an autonomous driving system of the motor vehicle, a communication system of the parking facility, a surround sensor system of the parking facility, a control system of the parking facility for controlling the driverless driving process, and a remote-control system of the parking facility for controlling the motor vehicle remotely.

19. The method as recited in claim 14, wherein, in the event of the fulfillment of the minimum condition that the responsibility for the motor vehicle was handed over by the driver, the handover of responsibility is documented electronically.

20. The method as recited in claim 14, wherein the beginning of the driverless driving process comprises a starting of the motor vehicle so that the motor vehicle is started only when the at least one minimum condition is fulfilled.

21. The method as recited in claim 14, wherein the driverless driving of the motor vehicle is begun only when all minimum conditions are fulfilled.

22. The method as recited in claim 14, wherein the destination position is one of a parking position of the parking facility or a pick-up position of the parking facility, at which a person is able to pick up the motor vehicle.

23. The method as recited in claim 14, wherein the checking including checking whether the minimum distance is maintained, the checking being performed by at least one of the motor vehicle and a vehicle-external parking facility management server of the parking facility.

24. The method as recited in claim 14, further comprising:
checking at least one of the following additional conditions are fulfilled:
the motor vehicle is parked correctly, and
the motor vehicle is locked;
beginning the driverless driving of the motor vehicle only when the at least one minimum condition is fulfilled and the at least one additional condition is fulfilled.

25. A device for the driverless driving of a motor vehicle parked at a start position of a parking facility from the start position to a destination position of the parking facility, the device being designed to:
check whether at least one of the following minimum conditions are fulfilled:
an order for the driverless driving exists,
the driver of the parked motor vehicle handed over responsibility for the parked motor vehicle, and
a minimum distance of one or multiple persons from the parked motor vehicle is maintained; and
begin the driverless driving of the motor vehicle only if the at least one minimum condition is fulfilled.

26. A non-transitory computer-readable storage medium on which is stored a computer program comprising program code for driverless driving of a motor vehicle parked at a start position of a parking facility from the start position to a destination position of the parking facility, the computer program, when executed by a processor, causing the processor to perform:
checking whether at least one of the following minimum conditions are fulfilled:
an order for the driverless driving exists,
the driver of the parked motor vehicle handed over responsibility for the parked motor vehicle, and
a minimum distance of one or multiple persons from the parked motor vehicle is maintained; and
beginning the driverless driving of the motor vehicle only if the at least one minimum condition is fulfilled.
